(19) United States
(12) Patent Application Publication
(10) Pub. No.: US 2005/0018883 A1
(43) Pub. Date: Jan. 27, 2005

(54) Systems and methods for facilitating transactions

(75) Inventor: Walter Guy Scott, North Palm Beach, FL (US)

Correspondence Address: STERNE, KESSLER, GOLDSTEIN & FOX PLLC, 1100 NEW YORK AVENUE, N.W., WASHINGTON, DC, 20005, US

(73) Assignee: Cross Match Technologies, Inc., Palm Beach Gardens, FL (US)

(21) Appl. No.: 10/887,187

(22) Filed: Jul. 9, 2004

Related U.S. Application Data
(60) Provisional application No. 60/485,446, filed on Jul. 9, 2003.

(51) Int. Cl. G06F 17/60; H04K 1/00

(52) U.S. Cl. 382/115; 705/64; 713/200

(57) ABSTRACT

The present invention provides systems and methods for enabling transactions in architecture that provides the users (both merchants and consumers) with simplicity, convenience and security. The systems introduces the new concept of a personality, which is a data set about an individual that can be securely brought close to a transaction to assist in facilitating the transaction. An interface secures the access to the personality based on a biometric presented by a user in a transaction. In one embodiment, architecture is provided for supporting biometrically secure transactions over networks.

### CROSS REFERENCE TO RELATED APPLICATIONS

This application claims the benefit of U.S. Provisional Application No. 60/485,446, filed Jul. 9, 2003, which is incorporated herein by reference in its entirety.

### FIELD OF THE INVENTION

The present invention relates to biometrics and transactions.

### BACKGROUND OF THE INVENTION

The growth of communications and processing power has enabled a variety of transactions over networks. These transactions can include retail, banking, government, commercial, education, personal and other types of transactions. Users can carry out transactions through devices such as, terminals, telephones, and computers.

FIG. 1 is a diagram of a marketplace 100 that supports limited conventional transactions. In marketplace 100, users 102A-102D carry out a variety of electronic transactions over network 120. User 102A interfaces with a terminal 104A at a merchant store in a retail transaction. Terminal 104A forwards information related to the user and/or transaction over network 120 to a bank 124 or credit card service 130 for approval. User 102B interfaces with an automated teller machine (ATM) 104B. ATM 104B communicates over network 120 to bank 124 or other institution to perform a banking transaction. User 102C interfaces with a computer 104C. Computer 104C carries out a transaction over network 120 with web server 125 to perform online banking, online retail or other e-commerce transactions. User 102D interfaces with telephone 104D to carry out a transaction over network 120. Telephone 104D generally has a more limited interface than computer 104C, but still can enable a user to input and make selections through a voice prompt or keypad system to perform transactions such as obtaining account information, or other types of telephone-supported transactions. Encryption can be used to encrypt data and communications over network 120.

Failings of marketplace 100 are identity security, transaction data access and a common system that supports the needs of both merchants and consumers. With respect to identity security, the rise of remote transactions has increased the need to securely identify a user in a transaction. In marketplace 100, cards, passwords, personal identification numbers (PINs), and electronic signatures are sometimes used to authenticate the identity of a user in a remote transaction. Cards, passwords, personal identification numbers (PINs), and electronic signatures, however, are vulnerable to theft as they can be stolen and used by others to carry out unauthorized transactions. Additional burdens are placed on users who have to carry cards, and track and remember associated passwords and PINs to carry out transactions properly.

Further, these security solutions often vary depending upon the specific devices and systems used to conduct transactions. Parties in a transaction (also called transacting entities) encounter a variety of interfaces of varying security. A person may need to present a bank card and a PIN to access cash at an automated teller machine (ATM). A person may need to swipe a credit card on a reader to carry out a credit card purchase with a merchant. A user may have to enter a PIN at a telephone to gain access to personal information associated with a transaction such as retrieval of account balance information.

In addition, access keys, PINs and passwords traditionally have been designed to fit the host or service supplier and present significant burden to the user (consumer). Some service providers have attempted to support key and PIN services on the personal computer in a World Wide Web environment, but this covers only a small fraction of the need.

Thus, the level of security provided in properly authenticating the identity of a user depends upon the particular devices and systems used to carry out a particular transaction. As a result of compromises in authenticating user identification, the level of security is often transaction-specific and uneven across marketplace 100. Further, the burden of properly authenticating a user's identity falls upon transacting entities such as merchants and the like. Authenticating a user identity based on a biometric presented by a user in a transaction can improve the security level but can be too costly or impractical for different transacting entities to implement in their own respective transaction systems and devices.

In addition to uneven security and complexity for users, the spread of different systems and devices for carrying out transactions makes it difficult to leverage data related to a transaction. Users generally provide separate data to each transacting entity. Transacting entities also have difficulty accessing data specific to a user and/or transaction that might facilitate a remote transaction.

What is needed are means for facilitating transactions without the limitations noted above.

### SUMMARY OF THE INVENTION

The present invention provides systems and methods for facilitating transactions. In embodiments, the present invention uses personality data, biometric security, encryption, and memory to carry out secure, remote transactions over networks. Personality data is leveraged to facilitate transactions. Leveraging can include using personality data, delivering personality data, and/or combining or extracting personality data from different sources.

In an embodiment, a biometric-interfaced enabled marketplace is provided. A memory stores secure personality data. An interface controls access to the secure personality data based on a biometric presented by a user in a transaction. The secure personality data includes a biometric identifier and user transaction data associated with a user. The interface grants access to the user transaction data when the user begins a transaction and a biometric presented by the user matches the biometric identifier. The biometric identifier includes data representative of a biometric. The biometric can be any type of biometric including but not limited to eye, hand, face, voice, and print biometrics. In one embodiment, the biometric is a print (e.g., a finger or thumb print) and the biometric identifier can be print data identifying the user, print image data, and/or data representative of print characteristics, such as, minutia data.

In one embodiment, a memory stores public personality data associated with the user. Data related to the transaction can be displayed to the user at a terminal based on the public personality data. Data related to the transaction can be sent to a third party service provider facilitating the transaction based on said public personality data. The public personality data also include a universal identifier that uniquely identifies the user participating in the transaction.

In one embodiment, a secure personal transceiver device (SPTD) is coupled to the biometric interface or terminal. The SPTD includes memory that stores secure personality data and public personality data. The SPTD includes a communications module for communicating over a link (e.g., a wireless link) to a network.

In one embodiment, a terminal interfaces with a user to carry out a transaction. The terminal communicates through a biometric interface to authenticate a biometric presented by the user prior to carrying out the transaction.

In one embodiment, an architecture is provided for supporting biometrically secure transactions over a network. The architecture includes local transaction devices that interface with users in transactions, a biometric interface coupled to local transaction devices, a transaction service provider that manages a transaction service allowing users to carry out transactions at local transaction devices, and an identity service provider that authenticates the identities of users at the local transaction device. The identity service provider and the transaction service provider are each coupled to the biometric interface. Memory stores secure personality data including biometric identifiers and user transaction data associated with users. The biometric interface includes a personality service manager that manages public and secure personality data, and a plurality of agents. The agents are coupled to each local transaction device, the identity service provider, and the transaction service provider. In an embodiment, the biometric interface includes at least one local user agent that receives biometric data representative of a biometric presented by a user in a transaction and/or at least one local terminal agent that notifies a corresponding local terminal when the identity of a user in a transaction has been authenticated by the identity service provider. Other agents include at least one identity service agent, coupled to the identity service provider. The identity service agent receives biometric data representative of a user captured in a transaction and user identity data. The identity service provider evaluates a first match condition between the biometric data representative of a user captured in a transaction with previously stored biometric data to determine a user's identity, evaluates a second match condition between the determined user identity and the user identity associated with the user in the transaction, and generates a signal indicating an authentication of the user in the transaction based on the first and second match conditions. The interface has at least one transaction service agent that manages a transaction being carried out with a user.

In an embodiment, a system is provided for enabling biometrically secure transactions, which includes memory that stores secure personality data and an interface that controls access to the secure personality data based on a biometric. The secure personality data includes a biometric identifier and user transaction service data. The interface can provide access to the biometric identifier so that transactions can be carried out with biometric level security. The interface can provide access to the user transaction service data so that transactions can be enhanced with the user transaction service data. Examples of user transaction service data include, but are not limited to, user-specific data related to carrying out transactions, such as, virtual wallet data, credit card data, digital receipts data, passwords, licenses, airline club data, hotel club data, shopping club data, merchant data, tickets, access control data, and/or coupons.

It is a feature of the present invention that it allows many different types of systems and devices to carry out transactions with biometric level security. Personality data (e.g., user specific transaction data) can be leveraged in any type of transaction over a network with biometric controls.

It is also a feature that remote transactions according to the present invention can be carried out across heterogeneous interfaces and systems.

Further embodiments, features, and advantages of the present inventions, as well as the structure and operation of the various embodiments of the present invention, are described in detail below with reference to the accompanying drawings.

### BRIEF DESCRIPTION OF THE FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a diagram of a marketplace without a biometric interface.

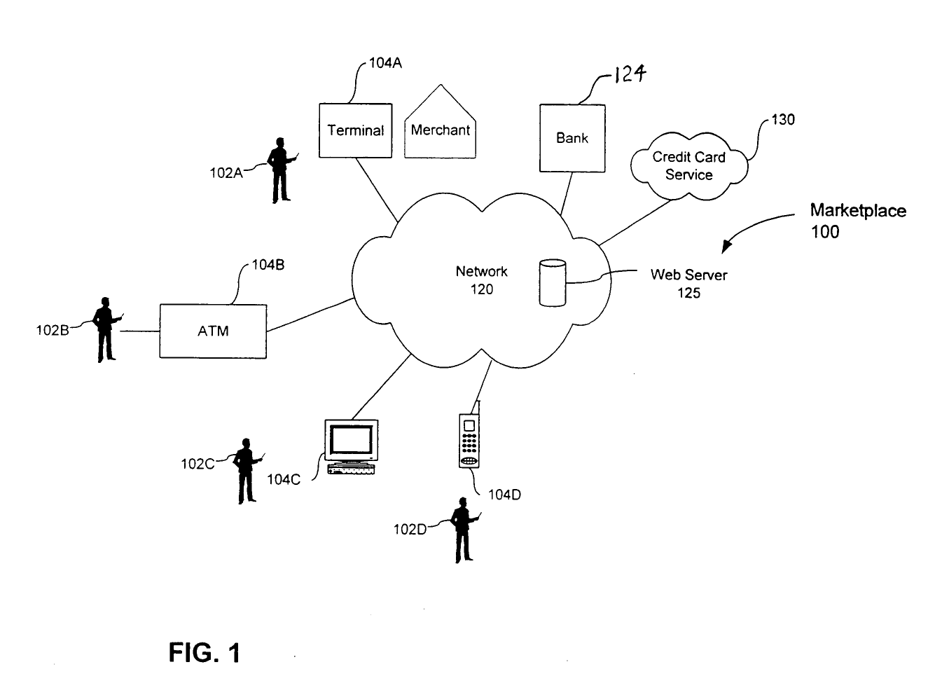

FIG. 2 is a diagram illustrating the use of memory, encryption, biometrics and communications according to an embodiment of the present invention.

FIG. 3 is a diagram of a biometric interface enabled marketplace according to an embodiment of the present invention.

FIG. 4 is a diagram of a biometric interface enabled marketplace according to an embodiment of the present invention.

FIG. 5 is a diagram that illustrates the biometric interface enabled marketplace of FIG. 4 in further detail.

FIG. 6 is a diagram of a biometric interface according to an embodiment of the present invention.

FIG. 7 is a diagram that illustrates two types of local transaction devices according to the present invention used with terminals in the biometric interface enabled marketplace of FIG. 4.

FIG. 8 is a diagram that illustrates one of the terminals in FIG. 7 in further detail.

FIG. 9 is a diagram that illustrates a secure personal transceiver device used in FIG. 7 in further detail.

FIG. 10 is a diagram that illustrates example user transaction service data according to an embodiment the present invention.

The present invention will now be described with reference to the accompanying drawings. In the drawings, like reference numbers can indicate identical or functionally similar elements. Additionally, the left-most digit(s) of a reference number may identify the drawing in which the reference number first appears.

### DETAILED DESCRIPTION OF THE INVENTION

### Table of Contents

1. Overview
2. Biometric Interface Enabled Marketplace
3. Further Embodiments
4. Agents
5. Example Terminal and Biometric Reader Configurations
6. Secure Personal Transceiver Device
7. Methods for Facilitating Transactions
8. Further Business Methods
9. Conclusion
   1. Overview

The present invention provides systems and methods for facilitating transactions. In these systems and methods, personality data is leveraged to facilitate transactions. Leveraging can include using personality data, delivering personality data, and/or combining or extracting personality data from different sources. In an embodiment, the present invention leverages personality data, biometric security, encryption, and memory to carry out secure, remote transactions over networks. In an embodiment, a biometric-interfaced enabled marketplace is provided.

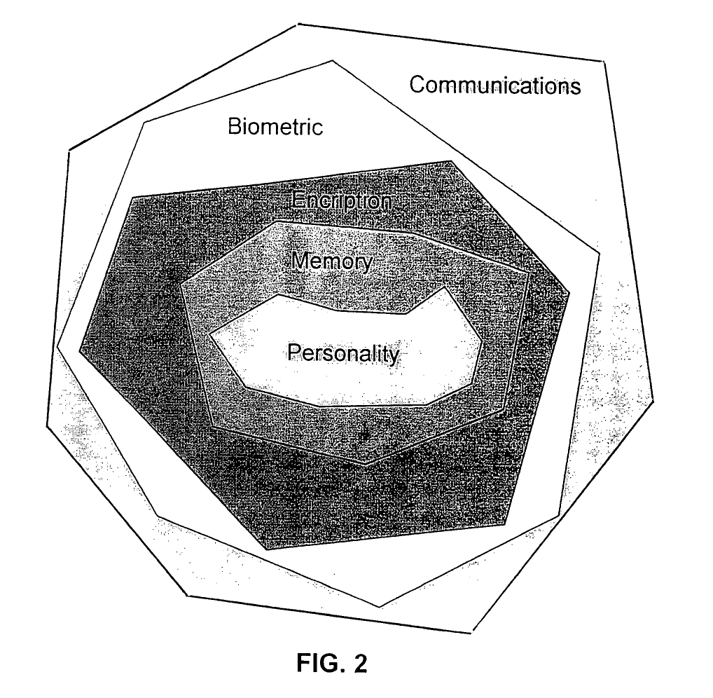

In embodiments, systems for carrying out the present invention include hardware, software and/or firmware for storage of the personality or a sub-section of the personality, encryption of the data in the storage, a biometric system to facilitate retrieval of the de-encryption keys and a communications system. In one embodiment the present invention, methods can be carried out using an architecture or hierarchy having a memory, an encryption system, a biometric system and a communication system to facilitate transactions in a convenient and secure method for the user as depicted by FIG. 2. The methods can be used with different types of personality data, memory, encryption, biometrics, and communication protocols. As each of the resources improve, the methods can be enhanced as in the case of the cost of the memory, the ruggedness of the encryption, the preciseness of the biometric or the speed and reliability and ubiquitousness of the communications.

2. Biometric Interface Enabled Marketplace

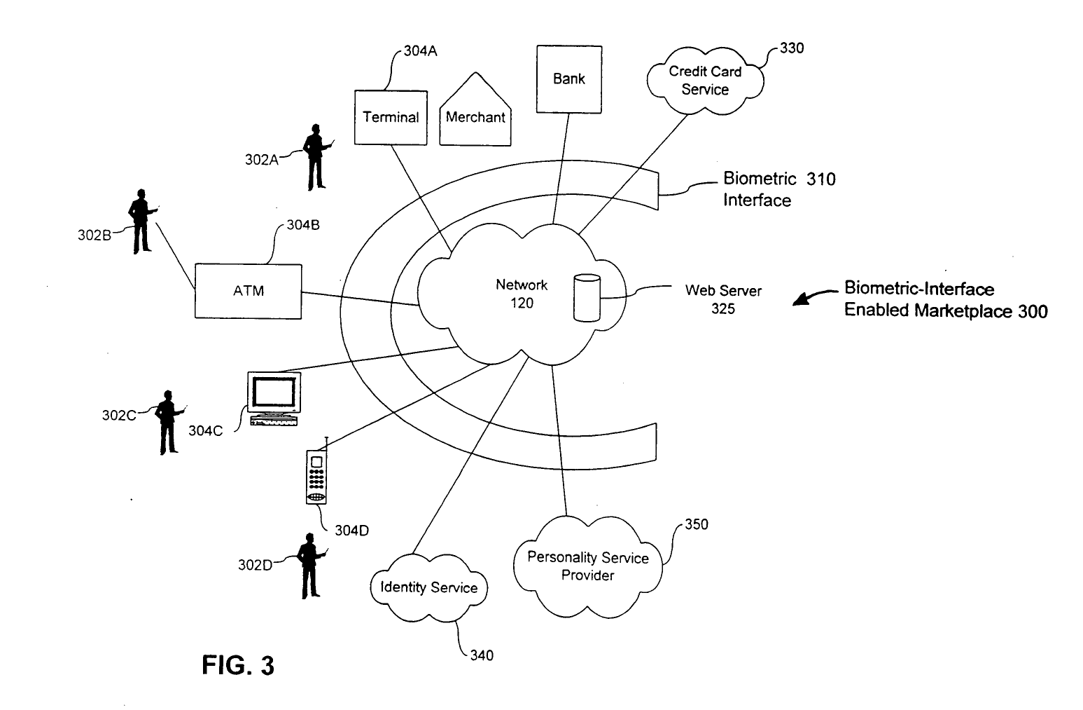

FIG. 3 is a diagram of a biometric interface enabled marketplace 300 according to an embodiment of the present invention. Biometric interface enabled marketplace 300 includes a biometric interface 310, identity service 340, and personality service provider 350. Biometric interface 310 couples a variety of users and local transaction devices to identity service 340 and personality service provider 350.

A user is an individual, association of individuals, business, organization, or other type of entity that utilizes the present invention. For example, an individual user can be a consumer in transactions undertaken with the present invention. An association of individuals, who together form a user, can be members of a particular service provider or merchant organization that provide services or products to the public (e.g., vendors). A financial institution providing, moving or storing funds or credit for a transaction will be referred to as a bank for brevity.

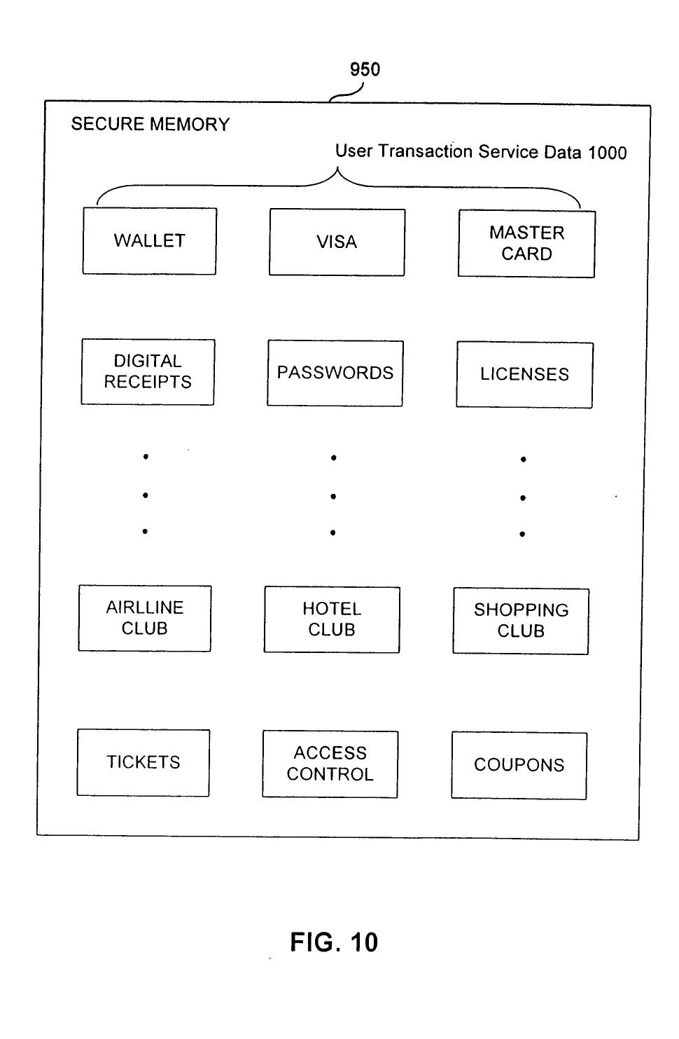

Identity service 340 provides an authentication of a user's identity based on a biometric presented by the user to a transaction. Personality service provider 350 manages secure personality data and public personality data. Secure personality data can include, but is not limited to, a biometric identifier and user transaction service data (e.g., a virtual wallet, credit card information, passwords, licenses, et cetera—see FIG. 10).

An individual has a personality and it is made up of the various features and characteristics both innate and acquired during their lifetime. Personality data can be any data relating to personality. Personality data includes the features and characteristics of an individual both innate and acquired up to present that can be documented. For example, an innate set of personality data can include birth date, parents, race, citizenship, medical characteristics, physical characteristics, and biometric characteristics. These innate features and characteristics generally do not change over an individual's lifetime. A transaction is an event where one or more users interact with personality data.

Other aspects of personality data include personal characteristics, financial characteristics, current lists, and/or access information. For example, one set of personal characteristics includes spouse, offspring, medical condition, and/or preferences. A set of financial characteristics includes credit history, credit accounts, employer data, bank accounts, liabilities, leases, and/or loans. Financial characteristics can be kept current by links to current accounts and tokens. A set of current lists includes shopping lists, telephone numbers, things to do, favorite foods and beverages, recipes, and/or appointments. Current lists can be changeable on a short-term basis by a user. A set of access information includes access keys, PINs and/or passwords.

Personality data can contain some data that by its very nature must be secured. Also, some personality data must be present and transferred to a third party to complete certain transactions. Individuals require their personality, represented by personality data, anywhere they wish to perform or prepare for a transaction.

Biometric interface 310 controls access to secure personality data based on a biometric. A secure memory stores the personality data, which can include a biometric identifier and user transaction service data, and biometric interface 310 grants access to user transaction service data when a user begins a transaction and the biometric presented by a user matches the biometric identifier in the secure personality data. In this way, biometric interface enabled marketplace 300 leverages developments in communications, electronic transactions, encryption, and biometrics. Biometric-level security can be provided to a number of remote transactions. These remote transactions can be between different systems and devices (including existing systems and devices), and can have any type of interface that can be coupled to biometric interface 310.

In embodiments, biometric interface 310 enables distributed access to personality data with biometric controls. Personality service provider 350 further allows management of public and private personality data. In this way, transacting entities can leverage personality data to facilitate transactions. For example, a user may select different types of information to be made available to pre-selected and/or approved transactions. Such information may include email address, home address, name, social security number or any other approved information. Likewise, transacting entities such as banks, merchants, credit card companies, insurance companies, financial entities, government entities or any other transacting entities may provide user-specific information to facilitate transactions. For example, American Express may provide specific information related to a user (preferred customer information, account information, user preferences, etc.) to facilitate carrying out retail, financial, or banking transactions. Such user transaction service data is stored in a secure memory accessed through biometric interface 310 when a proper biometric has been presented in the transaction. Biometric interface 310 enables access to the user transaction service data as appropriate for a particular transaction only when identity service 340 indicates that access should be granted. The use of encryption further ensures security for data passing to and from biometric interface 310.

In biometric interface enabled marketplace 300, users 302A-302D can carry out transactions over network 120 through a variety of types of local transaction devices 304A-304D. For example, user 302A may interface with a terminal 304A at a merchant site to carry out a retail transaction. Any conventional technique for conducting a purchase at a retailer can be used. For example, user 302A may present a credit card and/or PIN number to the merchant, who then swipes the credit card at terminal 304A. Biometric interface enabled marketplace 300 enables a merchant, however, to provide biometric-level security and enhance the transaction with personality data (e.g., user-specific transaction service data). User 302A presents a biometric, such as a fingerprint, to a terminal 304A. This presentation can be conducted by placing the user's fingerprint on a print scanner coupled to terminal 304A. Alternatively, the user 302A can place a finger on a secure personal transceiver device, which captures the fingerprint and beams the print information over a wireless link to terminal 304A. Terminal 304A forwards the captured biometric for a transaction to biometric interface 310.

Biometric interface 310 forwards data representative of the captured biometric to identity service 340. Preferably, terminal 304A also forwards information representative of the user's identity (such as, e.g., a user identifier (UID), full name, social security number, PIN number, etc.) to identity service 340 as well. In one embodiment, identity service 340 performs two matches. First, identity service 340 evaluates a first match condition between the biometric data representative of a user captured in a transaction with previously-stored biometric data to determine a user's identity. Identity service 340 also evaluates a second match condition between the determined user identity and the user identity associated with the user in the transaction. For example, based on the first match condition, identity service 340 can determine the identity of the user, such as the user's name. This user identity is matched with the identity information provided in the transaction to determine whether a second match condition is met. If the first and second match conditions are met, identity service 340 generates a signal indicating an authentication of the user in the transaction. This signal is returned to the biometric interface 310 and then to terminal 304A to permit the transaction to proceed.

Biometric interface 310 can also access secure personality data to enhance or facilitate the transaction with user 302A at terminal 304A. In one example, user 302A provides user identity information to terminal 304A, which forwards it to biometric interface 310. Biometric interface 310 forwards the user identity such as a UID to personality service provider 350. Personality service provider 350 accesses secure personality data associated with the user identity and forwards the secure data to terminal 304A only when identity service 340 indicates that an authentication of the identity of the user has been made. In many cases, secure data may not have to be forwarded to terminal 304A such as in cases where terminal 304A only needs a query answered or information confirmed.

User-specific transaction data can be any type of data developed by user 302A and/or a merchant to facilitate transactions with users. For example, merchants may offer a variety of levels of service to preferred customers based on the relationship of the customer to the merchant, the dollar volume or history of a customer with a merchant, or whether a customer has provided or enrolled in a special service offered by the merchant for preferred customers. In this way, preferred customers may receive additional information at a terminal such as coupons, approval to collect and store digital receipt information, account history information, or other types of enhanced service offerings. User 302A likewise can enroll in a variety of services offered by the merchants. In this way, a user can opt to have specific information made available for transactions at terminal 304A with the merchant. For example, a preferred user or business customer may prefer to have credit card information, coupons or special purchase information made available to a merchant at terminal 304A to facilitate transactions regardless of where the user 302A is located when making a purchase.

Users 302B-D can carry out similar transactions through biometric interface 310 through local devices 304B-D. User 302B presents a biometric at ATM 304B. This biometric can be presented to a live scanner coupled to ATM 304B or integrated with ATM 304B. Alternatively, a user may carry a portable secure transceiver device to capture a biometric and beam the biometric to ATM 304B. ATM 304B forwards the biometric to biometric interface 310. Biometric interface 310 carries out a transaction as described before, that has biometric level security, and can be facilitated or enhanced with access to user transaction service data when a user's identity, based on presentation of a biometric, has been authenticated. Similarly, user 302C can interface with computer 304C to carry out online transactions through a biometric interface 310. These online transactions can be carried out by presenting a biometric at computer 304C. Computer 304C forwards the biometric data to biometric interface 310, which interacts with identity service 340 and/or personality service provider 350, as described above, to provide biometric-level security and/or access to user transaction service data. Similarly, a user 302D can interact with a phone 304D to carry out a transaction. Through the use of biometric interface 310, biometric-level security can be provided to the transaction through a phone 304D, and user-specific transaction data can be provided as described before with respect to the other transaction devices.

The local transaction devices 304A-D are illustrative and not intended to limit the present invention. A person skilled in the art given this description would recognize that any type of local transaction device, known or developed in the future, can be used. Heterogeneous interfaces using a variety of local transactions devices can be installed and developed (along with existing interfaces), in a distributed fashion across a network, and yet still provide access to a biometric interface-enabled marketplace 300.

3. Further Embodiments

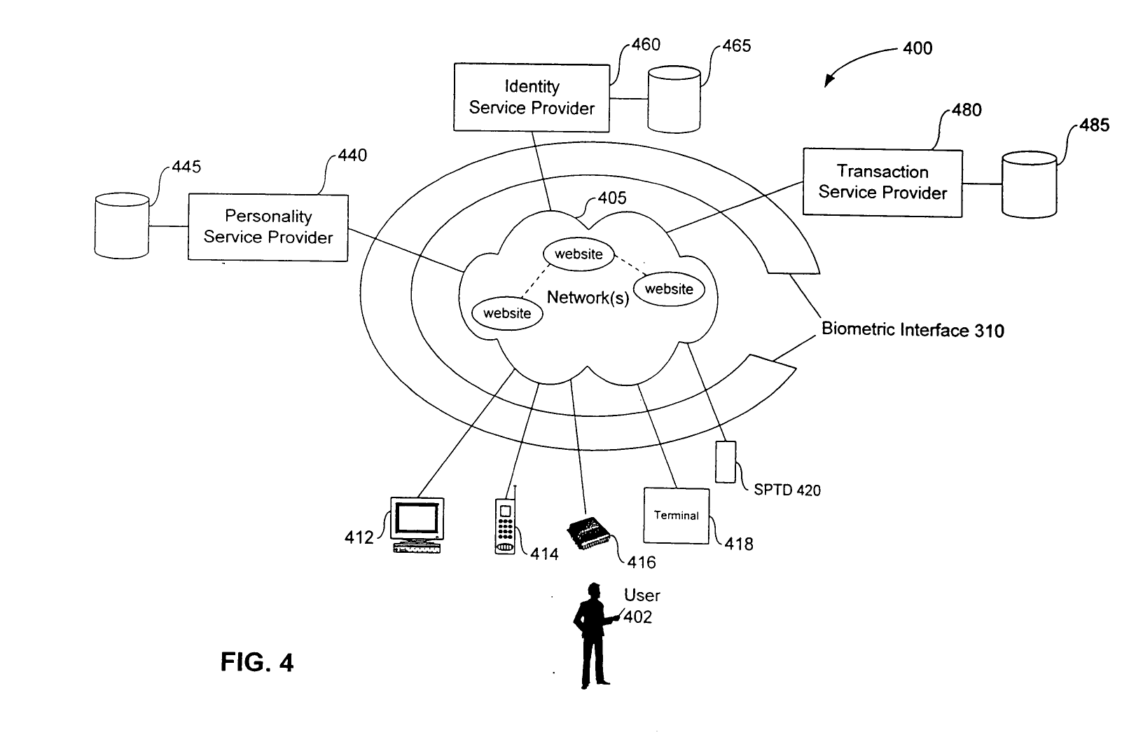

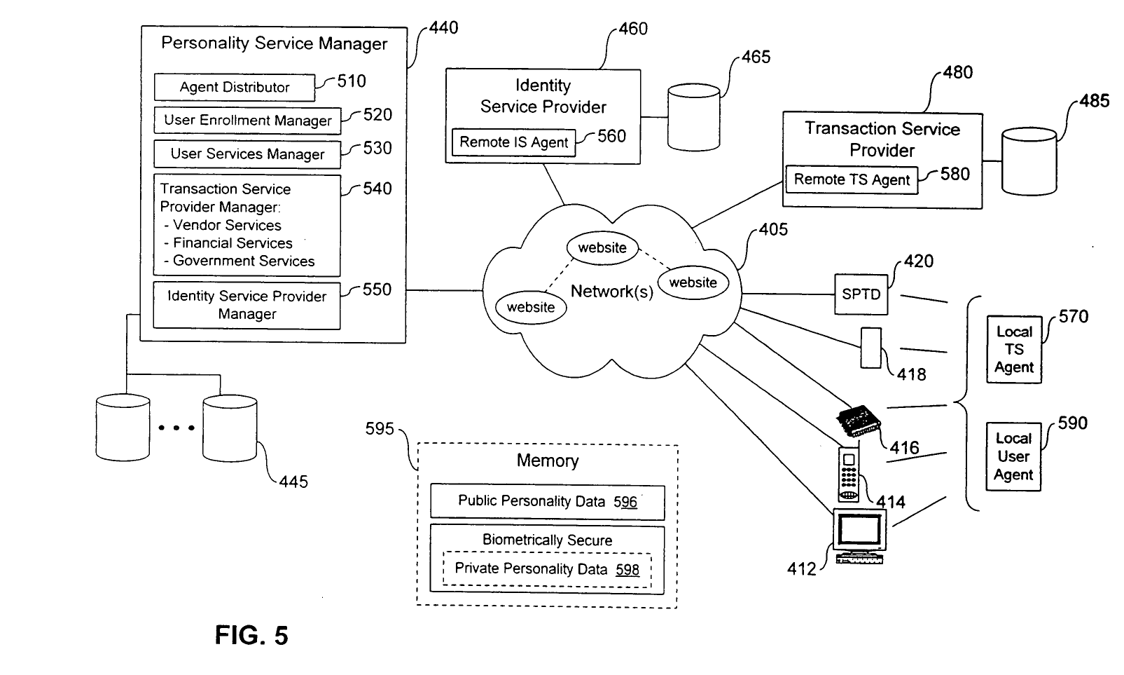

The biometric interface enabled marketplace of FIG. 3 will now be described in further detail with respect to embodiments shown in FIGS. 4 and 5. FIG. 4 shows an embodiment of a biometric interface enabled marketplace 400. Biometric interface enabled marketplace 400 includes biometric interface 310 coupled to transaction devices 412, 414, 416, 418, and secure personal transceiver device (SPTD) 420, personality service provider 440, identity service provider 460, and transaction service provider 480. A network 405 interconnects to the transaction devices 412, 414, 416, and 418, secure personal transceiver device 420, personality service provider 440, identity service provider 460, transaction service provider 480, and biometric interface 310. Network 405 can be any type of network or combination of networks, including but not limited to the Internet. Web technologies and protocols (such as HTTP or secure HTTP) can be used. As shown in FIG. 4, the transaction devices can include, but are not limited to, computer 412, telephone 414, processor device 416, and terminal device 418. Secure personal transceiver device 420 can include any type of portable, handheld transceiver device that can capture a biometric and forward biometric data over a link to biometric interface 310.

Personality service provider 440 is coupled to a database 445. Database 445 can be any type of relational or non-relational database for storing personality data. In one embodiment, this data includes, but is not limited to, public and private (secure) personality data.

Identity service provider 460 is coupled to database 465. Database 465 can include any type of relational or non-relational database for storing data related to providing an identity service. In one embodiment, this data includes, but is not limited, a database of biometric data associated with individuals such as fingerprint minutiae data.

Transaction service provider 480 is coupled to database 485. Database 485 can be a relational or non-relational database for storing data related to the transaction service. For example, this transaction service data can include data such as public and private (secure) personality data or it can include data merely indicative of enrollment and/or pre-approved selections made by users, merchants or other transacting entities.

User 402 interacts with any of the transactions devices to carry out transactions over network 405. User 402 need only present a biometric to carry out transactions with a biometric level of security. This is less burdensome on the user, as he or she merely needs to present a biometric such as a fingerprint. The biometric provides security, as it is difficult to imitate, steal or copy. In biometric interface enabled marketplace 400, user 402 is able to conduct transaction with a high degree of security and need not necessarily remember PINs or passwords, nor carry credit cards or debit cards. The present invention is not so limited, as PINs, bank cards, and passwords can be used in conjunction with biometric security as an additional feature for additional security and for supporting access to user transaction service data in enhanced transactions.

FIG. 5 illustrates the architecture of biometric interface enabled marketplace 400 in further detail. Personality service manager 440 includes an agent distributor 510, user enrollment manager 520, user services manager 530, transaction service provider manager 540, and identity service provider manager 550. This enables personality service manager 440 to be responsible for managing the maintenance and delivery of personality services to a biometric interface enabled marketplace. Identity service provider 460 includes a remote identity service (IS) agent 560. Transaction service provider 480 includes a remote transaction service (TS) agent 580. Transaction devices 412, 414, 416, and 418 each can include a local transaction service (TS) agent 570 and/or a local user agent 590. Similarly, secure personal transceiver device 420 can include a local TS agent 570 and/or a local user agent 590. A memory 595 is coupled to network 405 through biometric interface 310 (not shown). Memory 595 includes public personality data 596 and biometrically secure private personality data 598.

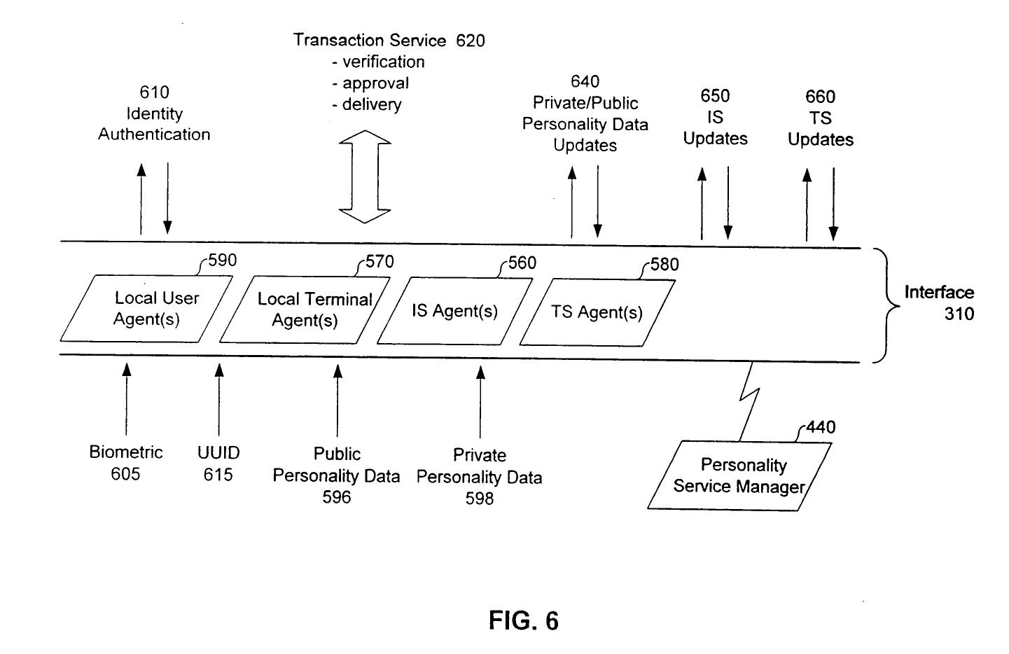

Agent distributor 510 is responsible for distributing the agents in biometric interface 310 (see FIG. 6). An agent refers to logic (such as software, firmware, and/or hardware) that enables functionality to be carried out to facilitate transactions according to the present invention.

User enrollment manager 520 manages enrollments of users in a personality service. Example user enrollment data can include but is not limited to user information such as name, address, social security number, and level of personality service.

User service manager 530 manages current levels of services made available to users subscribing to the personality service. For example, a user can select a level of service depending upon his or her needs. A user can select a minimal level of service, which involves rolling biometric data associated with the user. This biometric data is stored and made available by the identity service provider so that biometric level of security can be provided in transactions through biometric interface 310. A higher level of service may further include enrolling user specific transaction data. This user specific transaction data also can be made available to transaction service providers and/or local transaction devices so that enhanced transactions can be performed. Such services may include providing frequent flyer information, preferred customer information and other types of preferred services to users.

A service provider utilizes the present invention to assist users with carrying out transactions using features of the present invention. Service providers provide facilities like communications, storage, identity verification, security (such as encryption), software, and hardware.

Transaction service provider manager 540 manages transaction services affiliated with a biometric interface enabled marketplace. Transaction service provider manager 540 manages all the transaction service providers 480. These transaction service providers 480 can include for example but are not limited to vender services, financial services, government services and education services. Transaction service provider manager 540 tracks which transaction service providers are currently enrolled, specific requirements of transaction service providers and other data related to managing transaction service providers 480.

Identity service provider manager 550 manages identity service providers 460. Identity service provider manager 550 can store data identifying currently enrolled identity service providers 460, specific requirements of identity service providers 460 and other information related to managing identity service providers 460.

FIG. 6 illustrates biometric interface 310 in further detail according to an embodiment of the present invention. Biometric interface 310 includes a plurality of agents. These agents are distributed to local transaction devices and service providers to form biometric interface 310.

As shown in FIG. 6, in an embodiment, biometric interface 310 can include local user agent(s) 590, local terminal agent(s) 570, identity service (IS) agent(s) 560, transaction service agent(s) 580, and the personality service manager 440. Biometric interface 310 receives biometric data 605, user identity data 615 (such as a UUID), public personality data 596 and private personality data 598. Interface 310 (including IS agent(s) 560) passes data relating to identity authentication 610 to and from identity service provider 460. Interface 310 (including TS agent(s) 580) passes data relating to transaction service 620 (verification, approval and delivery of transaction services) to and from transaction service provider 480. Interface 310 also interacts to provide updates and changes 640 to private and public personality data to and from personality service manager 440. Similarly, interface 310 (including IS agent(s) 560) interacts with identity service provider 460 to provide IS updates and changes 650. Interface 310 (including TS agent(s) 580) interacts with transaction service providers 480 to provide updates and changes 660.

4. Agents

As mentioned above, agent distributor 510 is responsible for managing and distributing remote IS agent(s) 560, remote TS agent(s) 580, local TS agent(s) 570, and local user agent(s) 590. Remote IS agent(s) 560 enable identity service provider 460 to coordinate with interface 310. Remote IS agent(s) 560 can communicate with personality service manager 440. In one embodiment, remote IS agent(s) 560 are any type of software, firmware, hardware or any combination thereof that can carry out the functionality of communicating between identity service provider 460 and biometric interface 310.

Remote TS agent(s) 580 interface between transaction service provider 480 and other components including personality service manager 440 and transaction devices 412, 414, 416, 418 and SPTD 420. Local TS agent(s) 570 interface between a transaction device or SPTD and transaction service provider 480 (and/or remote TS agent(s) 580). Local user agent(s) 590 interface between a transaction device or SPTD and personality manager 440, identity service provider 460, and/or transaction service provider 480. Local TS agent(s) 570 act to carry out a transaction service corresponding to a particular transaction service provider 480. Local user agent(s) 590 act to carry out transactions associated with a specific user. Each of the agents can be implemented in software, firmware, hardware or any combination thereof. Agent distributor 510 can distribute applets across network 405 or object code or other control program logic to distribute agents across a biometric interface enabled marketplace.

As shown in FIG. 6, interface 310 represents the functionality needed to carry out a biometric interface enabled marketplace. Interface 310 includes agents 560-590 distributed by agent distributor 510. Interface 310 interacts and is coupled to personality service manager 440 for guiding and distributing public and private (secure) personality data as appropriate across the marketplace.

5. Example Terminal and Biometric Reader Configurations

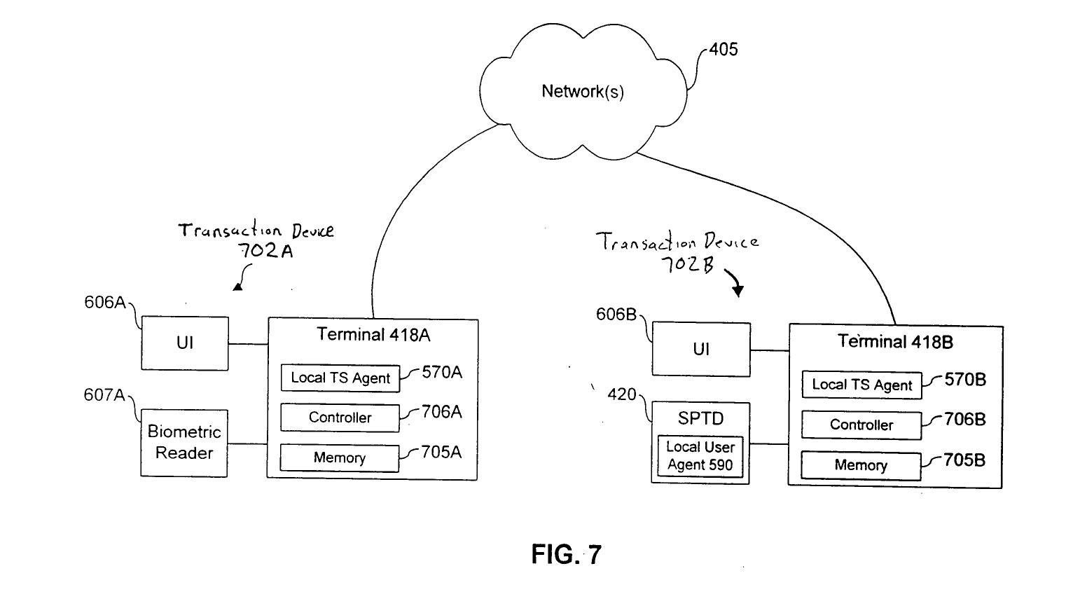

FIG. 7 is a diagram that illustrates two example types of transaction devices 702A and 702B used with terminals 418A and 418B in the biometric interface enabled marketplace 400 of FIG. 4. As shown in FIG. 7, one type of local transaction device 702A includes a user interface (UI) 606A and biometric reader 607A coupled to terminal 418A. Terminal 418A further includes a local TS agent 570A, controller 706A, and memory 705A. User interface 606A can be any type of user interface for receiving inputs from a user and for providing display or other types of outputs to a user. For example, user interface 606A can include but is not limited to buttons, screen displays, tactile or pressure sensitive device, switches or other types of user interfaces. Biometric reader 607A can be any type of biometric reader including but not limited to a live print scanner, retinal scanner or other type of biometric reader. Controller 706A coordinates and controls the operation of terminal 418A. Memory 705A stores data associated with users including public and private personality data.

Transaction device 702B alternatively includes a UI 606B and secure personal transaction device (SPTD) 420 coupled to terminal 418B. Terminal 418B includes local TS agent 570B, controller 706B and memory 705B. Local user agent 590 is downloaded into SPTD 420 as shown in FIG. 7. Controller 706B controls the operation of terminal 418B. Memory 705B can store public and private personality data.

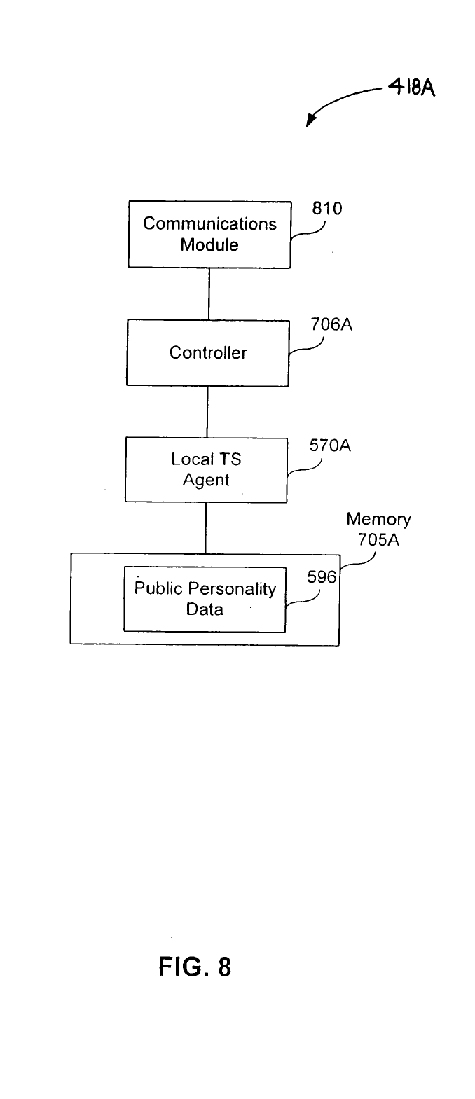

FIG. 8 is a diagram of terminal 418A in further detail. Communications module 810 is coupled to controller 706A and local TS agent 570A. Communication module 810 communicates between terminal 418A and network 405. Controller 706A controls the operation of communication module 810 and local TS agent 570A. Memory 705A includes public personality data 596. In this way, by installing a local TS agent 570 and storing public personality data 596, terminal 418A can be made compatible with a biometric interface enabled marketplace. All remaining existing hardware and software in terminal 418A can be unchanged and used as in other transactions.

6. Secure Personal Transceiver Device

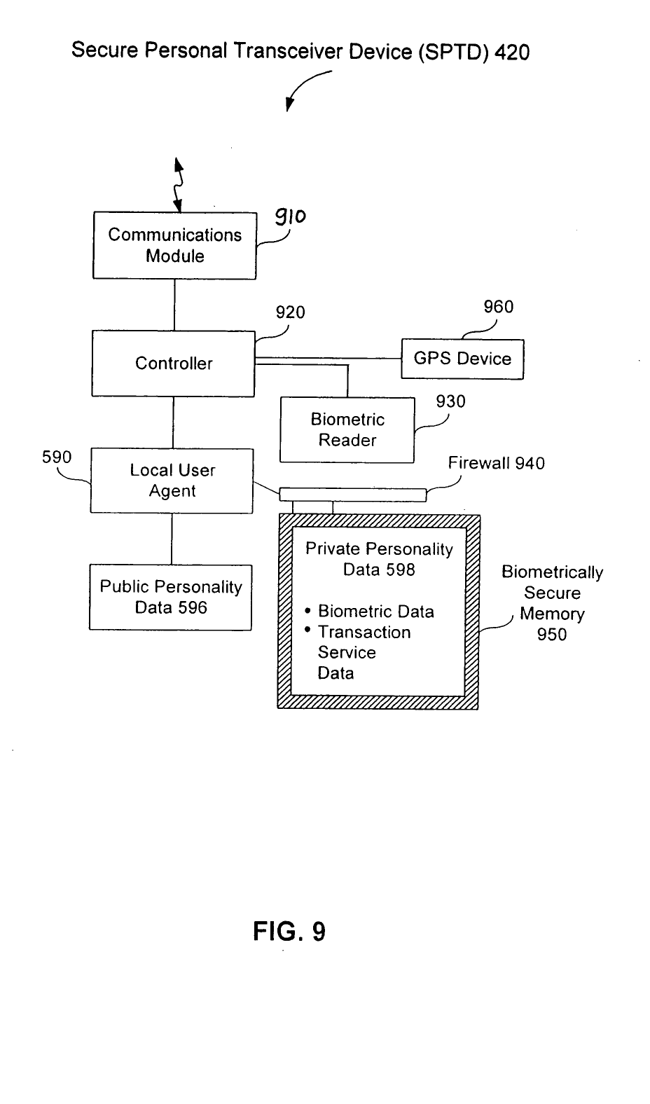

FIG. 9 is a diagram that shows secure personal transceiver device (SPTD) 420 in further detail. In an embodiment, SPTD 420 includes a communications module 910, a controller 920, a biometric reader 930 and an optional GPS device 960.

Communications module 910 can be any type of communications model including but not limited to a communications supporting communication over a wireless link or a cable or other type of link, for example, with network 405.

Controller 920 is coupled to local user agent 590, which can access public personality data 596 and private personality data 598 via a firewall 940. Firewall 940 can be any type of firewall including but not limited to a software firewall. Firewall 940 protects data in a biometrically secure memory 950 from unauthorized access. Public personality data 596 can be data related to a transaction that a particular transaction service makes available to facilitate or expedite handling of remote transactions. Biometrically secure member 950 stores private personality data 598. Private personality data 598 can include biometric data and user transaction service data. User transaction service data stored in memory 950 is secure.

Biometric reader 930 can be any type of biometric reader including but not limited to a print scanner.

GPS device 960 provides a GPS signal indicative of a global position of the SPTD 420. In this way, SPTD 420 can provide an indication of the location of the SPTD 420 for example to biometric interface enabled marketplace 400.

By installing local user agent 590 (see FIG. 7) and downloading public personality data 596 and private personality data 598, a SPTD device 420 can be made compatible with biometric interface marketplace 400. By carrying SPTD 420, a user can store public personality data 596 related to transactions in which the user frequently or desirably engages. This data is secure as it can only be presented upon presentation of the proper user biometric (e.g., a print). A user can also download and store private personality data 598 including a biometric and user transaction service data to facilitate interaction and carrying out of transactions with biometric interface enabled marketplace 400. For example, a user can enroll and download biometric data associated with himself or herself through an enrollment process. Likewise, the user can download user transaction service data through a user service enrollment process. In this way, the user can control the distribution of biometric data and storage of user transaction service data in his or her SPTD 420.

FIG. 10 shows exemplary user transaction service data 1000 that might be stored in secure memory 950. In the example of FIG. 10, a user stores user transaction service data related to a virtual wallet, credit card services such as Visa and MasterCard, digital receipts, passwords, licenses, airline clubs, hotel clubs, shopping clubs, tickets, access control data, and coupons. This example is illustrative and not intended to limit the specific types of user transaction service data that may be used.

7. Methods for Facilitating Transactions

Methods for facilitating transactions among users with biometric security and access to personality data are provided. In many cases, several users will be interacting during a transaction and using personality data or derivatives of the personality. For example, in a purchase transaction requiring bank approval, a first user (consumer), a second user (vendor), a third user (financial institution), and a fourth user (governmental body) may be involved to transfer the title of the good(s) sold and to transfer suitable funds and to collect taxes due, if applicable, on the transaction. In other transactions, a single user and the user's personality data may be involved such as, for example, when a user retrieves a memo, a recipe, an appointment (time, date, and location information), or other data.

In one embodiment, a user (consumer) fills out a form supplied by a service provider (software supplier) with sub-sections (preferences) of his or her personality that is then stored in a memory (digital vault) supplied by another service provider (hardware supplier). The information on the form can be secure (restricted) or public, which defines the access process to the information in memory (a digital vault). When filling out the form, the user (consumer) has access to information and resources that assist the user in the procedure. The form can be on paper for later entry or on a terminal equipped with suitable software and resources to add the information to the user's personality. At some later time, the user could use the preferences (a sub-section of their personality or personality data) to facilitate a transaction. In the present invention, one or several service providers could be called upon to deliver the appropriate preferences to the parties (users) involved in the transaction.

In an embodiment, a memory service supplier (digital vaulting company), an encryption service supplier, a communications service supplier, a biometric service supplier, a software program supplier and a terminal service supplier are utilized to complete a transaction according to the present invention. The service suppliers can be operating on a fee for service basis, a contracted fee for a user basis, or a no fee such as, for example, the World Wide Web. This embodiment uses a memory for storage of a personality, represented by personality data, an encryption system for securing the personality in the memory, a biometric system for validating the credentials of the personality's owner, and a communication system for moving the encrypted personality or parts of the personality. As a result of a transaction, various pieces of data relating to the transaction will most likely be added to the user's (consumer's) personality such as the changes in financial status, warrantee information, receipts, reminders for action such as service or check in dates and payment dates. As a result of the transaction, the user (consumer) may wish to purchase services such as a loan for the cost of goods, an accounting function for discernment of the receipt for appropriate expense account reimbursement or taxation appropriation, or installation payment withdrawals form an account.

In one embodiment a basic or enhanced personality software interface could be sold or leased to a user (consumer) to facilitate personal functions that could include reminders of upcoming events in a suitable time, memos, recipes, receipts, and other data that the user may wish to have available at all times or any location. This data could be categorized as secure (restricted) or public by the owner. Personalities can potentially grow to large databases, which will require categorizing by the personality software interface and will probably incur fees by the agents supporting the personality.

In one embodiment, the personality user could indicate via the personality software interface that he or she is open to solicitations for various classes of products or services for a specific time (i.e., the user is wishing to shop for a class of objects or services). This type of personality data would most likely be store with a public or restricted security level. Service providers could then supply a service of searching for or accepting advertisements, vouchers, and coupons and adding links or data to the personality of the user in an appropriate sub-section. Service providers (in this case performing as a virtual shop) could be employed to select the best solicitation for the user based on criteria selected by the user such as price, location, and/or quality. Service providers could charge a fee to the user or the vendor for providing their service. Service providers could also bring to the transaction other services to facilitate completion of the transaction such as transport companies, finance companies, and storage companies.

In one embodiment, a terminal used at the location of a transaction to facilitate the transaction would include, a biometric system, a memory, an encryption system and a communication system. This could take many physical forms including separate components that are gathered temporarily at the location of the transaction only for that transaction. For example, the terminal could consist of a cash register connected to the World Wide Web and a biometric system and appropriate software for performing biometric and encryption functions. As another example, the terminal could comprise a cell phone owned by the user (consumer) or the user (vendor), or a fixed telephone owned by the user or a third party (agent), equipped with a memory, and biometric and encryption systems. The terminal also could comprise, for example, a personal device carried by the user that contains a memory, a biometric system, an encryption system and a communications system. If the terminal or part of the terminal is possessed by the user (consumer), advantage can be made of the UUID (universally unique identification number) of the device to facilitate the transaction (e.g., identifying, validating, and securely retrieving appropriate sections of the personality needed to accomplish the transaction). If the vendor possesses the UUID, the terminal or MAC address can be used to assist in the appropriate retrieval of data required to perform the transaction.

In one example, multiple users (e.g., consumer and vendor) each supply part of the physical terminal at the point of transaction.

In one embodiment, a first user (consumer) employs a second user (financial institution) to provide a wallet facility in his or her personality. This wallet facility could be set for limits of the value of a transaction based on security levels of authorization. This could mean that a section of the personality containing the wallet facility could be stored in a memory of a Bluetooth equipped cell phone that would enable the user (consumer) to purchase goods from a Bluetooth equipped vending machine depending on the price with or without a biometric system identity check. Vending machines would be considered to include parking meters, parking garages, toll way fees, bridge fees and transportation fees in trains and boats and planes. Agents could be used to consolidate public, corporate, local authority; city, county, state and federal fee for use collection via one common convenient device (cell phone or Secure Personal Transceiver Device (SPTD); See, e.g., FIG. 9) possessed by the user (consumer).

A personality service program facilitates the storage and retrieval of sections of a personality and defines the subsections and the registry much like a software operating system. Service providers add functionality to the basic personality program much like vendors of software programs. The service providers (and their associated agents) are required to conform to standards defined in the basic personality service program to remain compatible with other service providers that provide other services required for the transactions. It is not necessary to define the hardware required for each function of this method as it could facilitate services as yet to be envisioned with hardware yet to be developed.

In one embodiment, a service provider can offer the service of personality back up storage for use in the event of a catastrophe (i.e., loss or corruption of personality data). This back up storage could be in the form of silicon memory, magnetic media, optical media or printed-paper as best seen by the user to suit their needs. In most cases, the storage will need to be secured and sections will contain information that if known to others could be used to disadvantage the user. In most cases today, the personality would be stored in machine-readable format and, to prevent unauthorized use, would be best secured by encryption with the keys secured by a biometric authentication of the identity of the user. There are however many alternatives, the most common today would be to print the data that makes up the sub-sections of the user's personality and secure the paper in a location that is not accessible to the public. Most commonly today, this location is not even secured by a key lock, and the data flows out in the form of paper into waste disposal services that are totally unsecured. The present invention works to replace the current systems in a more convenient, searchable and retrievable, and secure method that makes the personality available at any location equipped with communications only to the user or to user authorized third parties.

8. Further Business Methods

In one embodiment, revenue is generated by managing biometric interface 310 and personality service manager 440. In particular, revenue is charged on a per transaction basis for each transaction carried out over biometric interface enabled marketplace 400. A user monthly service fee is also charged depending upon the particular level of service provided to enrolled users. A service provider participant fee is charged for transaction service providers that participate in biometric interface enabled marketplace 400.

### 9. CONCLUSION

While specific embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

1. A system for enabling biometrically secure transactions, comprising:
memory that stores secure personality data; and
an interface that controls access to said secure personality data based on a biometric,
wherein said secure personality data includes' a biometric identifier and user transaction service data associated with a user, and said interface grants access to said user transaction service data when the user begins a transaction and a biometric presented by the user matches said biometric identifier.

2. The system of claim 1, wherein said biometric identifier comprises print data identifying the user.

3. The system of claim 1, wherein said print data comprises print image data.

4. The system of claim 1, wherein said print data comprises data representative of print characteristics.

5. The system of claim 4, wherein said data representative of print characteristics includes minutia data of at least one print associated with the user.

6. The system of claim 1, wherein said biometric identifier comprises data representative of a biometric, said biometric being a biometric selected from the group of eye, hand, face, voice, and print biometrics.

7. The system of claim 1, further comprising:
memory that stores public personality data associated with the user, whereby data related to the transaction can be displayed to the user at a terminal based on said public personality data.

8. The system of claim 1, further comprising:
memory that stores public personality data associated with the user, whereby data related to the transaction can be sent to a third party service provider facilitating the transaction based on said public personality data.

9. The system of claim 1, further comprising:
memory that stores public personality data associated with the user, wherein said public personality data include a universal identifier that uniquely identifies the user participating in the transaction.

10. The system of claim 9, wherein said memory that stores secure personality data and said memory stores public personality data are each provided in a secure personal transceiver device.

11. The system of claim 10, wherein said secure personal transceiver device includes a communications module for communicating over a link.

12. The system of claim 12, wherein the link comprises a wireless link.

13. The system of claim 1, further comprising a terminal for carrying out the transaction; and wherein said terminal communicates through said interface to authenticate a biometric presented by the user prior to carrying out the transaction.

14. An architecture for supporting biometrically secure transactions over a network, comprising:
transaction devices that interface with users in transactions;
a biometric interface coupled to said transaction devices;
a transaction service provider that manages a transaction service allowing users to carry out transactions at transaction devices;
an identity service provider that authenticates users identities at said transaction device; wherein said identity service provider and said transaction service provider are each coupled to said biometric interface; and
memory that stores secure personality data including biometric identifiers and user transaction data associated with users.

15. The architecture of claim 14, wherein said biometric interface comprises a personality service manager that manages public and secure personality data.

16. The architecture of claim 14, wherein said biometric interface comprises a plurality of agents coupled to one or more of said transaction device, said identity service provider, and said transaction service provider.

17. The architecture of claim 14, wherein said interface comprises at least one local user agent that receives biometric data representative of a biometric presented by a user in a transaction.

18. The architecture of claim 14, wherein said interface comprises at least one local terminal agent that notifies a corresponding local terminal when the identity of a user in a transaction has been authenticated by the identity service provider.

19. The architecture of claim 14, wherein said interface comprises at least one identity service agent, coupled to said identity service provider, wherein said identity service agent receives biometric data representative of a user captured in a transaction and user identity data, and wherein said identity service provider evaluates a first match condition between said biometric data representative of a user captured in a transaction with previously stored biometric data to determine a user's identity, evaluates a second match condition between said determined user identity and said user identity associated with the user in the transaction, and generates a signal indicating an authentication of the user in the transaction based on said first and second match conditions.

20. The architecture of claim 14, wherein said interface comprises at least one transaction service agent that manages a transaction being carried out with a user.

21. A system for enabling biometrically secure transactions, comprising:
memory that stores secure personality data; and
an interface that controls access to said secure personality data based on a biometric.
